(19) United States
(12) Patent Application Publication
(10) Pub. No.: US 2005/0083039 A1
(43) Pub. Date: Apr. 21, 2005

(54) Adjusting device for a motor vehicle

(76) Inventors: Achim Kullmann, Erlangen (DE); Dalibor Rietdijk, Wetzlar (DE)

Correspondence Address: CHRISTIE, PARKER & HALE, LLP, PO BOX 7068, PASADENA, CA, 91109-7068, US

(21) Appl. No.: 10/929,330

(22) Filed: Aug. 30, 2004

(30) Foreign Application Priority Data
Aug. 28, 2003 (DE) 103 40 203.9

(51) Int. Cl. G01B 7/14

(52) U.S. Cl. 324/207.13; 324/658

(57) ABSTRACT

The invention relates to an adjusting device for a motor vehicle for adjusting a movable element (1) of the adjusting device with a sensor system comprising at least one active sensor part (3) and at least one passive sensor part (12). The object of the invention is to disclose an adjusting device which may be produced particularly easily and inexpensively.

This object is achieved according to the invention in that the active sensor part (3) is a fixed capacitive sensor and the passive sensor part (12) forms a component of the movable element (1).

### CROSS REFERENCE TO RELATED APPLICATIONS

This application is based on copending German patent application 103 40 203.9 filed on 28 Aug. 2003.

### DESCRIPTION

The invention relates to an adjusting device for a motor vehicle for adjusting a movable element of the adjusting device. The adjusting device comprises a sensor system with at least one active sensor part and at least one passive sensor part. The sensor system is used for measuring or determining the position or location of the movable element. Active sensor part is hereinafter taken to mean the part of the sensor system that generates an analogue or digital sensor signal which directly indicates the position or the location of the movable element or from which or with which the position or location of the movable element can be indirectly determined. Passive sensor part is taken to mean the component of the sensor system that changes a physical variable, for example the magnetic field, the electrical field or the like, in the region of the active sensor part, in such a way that it can be determined by the active sensor part and can be detected while forming the sensor signal.

An adjusting device of this type is known, for example, from the international patent application WO 00/54010. In this known adjusting device the passive sensor part is formed by a magnetic rod in which the angle of the magnetic field rotates in the longitudinal direction of the rod. By measuring the direction of the magnetic field with the aid of the active sensor part the absolute location of the movable element may be determined.

The object of the invention is to disclose an adjusting device which may be produced as easily and inexpensively as possible.

This object is achieved according to the invention in an adjusting device of the type described at the outset by the characterising features of claim 1. Advantageous developments of the invention are recited in the sub-claims.

Therefore, according to the invention it is provided that the active sensor part is stationarily arranged and is formed by a capacitive sensor. The passive sensor part forms a component of the movable element.

The adjusting device is advantageously constructed in such a way that a capacitive sensor is used as the active sensor part. Capacitive sensors may be constructed in the simplest form, for example by just two capacitor plates, so the active sensor part can be produced very inexpensively in the adjusting device according to the invention.

The passive sensor part is advantageously an integral component of the movable element, so the passive sensor part may also be produced “simultaneously” when producing the movable element. The passive sensor part is advantageously moulded in one piece on the movable element.

If digital output signals are to be generated to determine the location of the movable element, the passive sensor part preferably has a toothed profile which changes the electrical field very abruptly when the active sensor part is passed. Approximately rectangular output signals, in other words more or less digital signals, are then output by the active sensor part.

If, instead, analogue output signals are to be generated, the passive sensor part preferably has a sinusoidal profile as the capacitance-changing profile.

If the respective “absolute” position of the movable element is to be measured, the capacitance-changing profile of the passive sensor part can have a monotonously increasing or a monotonously decreasing characteristic. By measuring the electrical field strength in the region of the active sensor part or by measuring the capacitance of the active sensor part, the absolute location of the movable element may be determined. An increasing or decreasing profile can moreover also be used to initialise or standardise the position measuring system or for synchronisation with a further relative position measuring system, however. Measuring tolerances by way of example may thus be eliminated or at least reduced.

An absolute location measurement is moreover possible with the aid of the sensor system if the passive sensor part comprises at least two sensor tracks. The absolute position of the movable element can be determined by corresponding coding of the two sensor tracks relative to each other.

The profile of the passive sensor part may be formed particularly inexpensively and easily by appropriate configuration of a plastics material. For example, the plastics material can be sprayed or injected onto a carrier part with the predetermined profile, in particular by forming what is known as “outsert” part. The carrier part preferably consists of metal, for example a flat metal sheet. Alternatively, the carrier part itself can have a capacitance-changing profile, so the carrier part forms a separate “sensor track”.

The active sensor part is preferably clipped by means of a clip element to a carrier element secured to the car body. The clip element can, for example, be formed from plastics material. The clip element is preferably connected in one piece to a housing of the active sensor part in order to keep the production costs as low as possible.

In order to be able to form an abutment face for the movable element of the adjusting device particularly easily and inexpensively, it is deemed advantageous according to a development of the adjusting device if the housing of the active sensor part comprises at least one abutment face for the movable element, on which face the movable element abuts in its upper and/or lower end position. An additional separate stop can therefore be dispensed with when the abutment face is integrated in the housing of the sensor part.

The sensor system preferably comprises an evaluation device, in particular an electronic circuit, which evaluates the sensor signal of the active sensor part. The evaluation device is preferably configured in such at way that, from the sensor signal of the active sensor part, it forms an analogue or digital measuring signal which indicates the absolute or relative position of the movable element. The evaluation device can, for example, be stationarily fastened.

The evaluation device is advantageously housed in the housing of the active sensor part so a separate housing for the evaluation device is dispensed with. The evaluation device is preferably connected by at least one cable to a controller of the adjusting device connected to a drive of the adjusting device. The controller is configured in this case in such a way that it evaluates the analogue or digital measuring signal of the evaluation device and controls the drive by taking into account the absolute or relative position of the movable element. Alternatively, a radio link can of course be used between the controller and the evaluation device instead of a cable.

If the evaluation device is housed in the wet location of the motor vehicle it is deemed to be advantageous if the at least one cable and the housing of the evaluation device are connected in a water-tight manner to avoid damage owing to moisture. The same applies if the evaluation device is housed in the housing of the active sensor part.

The water-tight connection between the cable and the housing of the evaluation device and the housing of the active sensor part can be inexpensively and therefore advantageously brought about in that the end of the cable facing the housing and the housing are jointly encapsulated by plastics material. Expensive wet location plugs can therefore be dispensed with.

The passive sensor part can, for example, be arranged on a cable drum of a drive system of the adjusting device and, more precisely, irrespective of whether the adjusting device is a window opener, a seat adjuster, a sliding roof or another vehicle component. The passive sensor part can instead also be arranged on a deflection pulley, via which a flexible traction mechanism, for example a drive cable, is guided.

The adjusting device can in particular be a cable window opener. The passive sensor part of the sensor system is then advantageously fastened to a driving element for the windowpane of the window opener. The active sensor part is preferably provided on a guide rail of the window opener.

To fasten the driving element on the associated guide rail of the window opener, the opener preferably comprises guide slots which are L-shaped in cross-section, and through which the associated guide rail is passed.

A fastening region of the driving element—in particular a clamping jaw of the fastening region, for example—used to fasten the windowpane preferably consists of metal and is connected to a sliding region (made of plastics material) of the driving element guided by the guide rail of the window opener by plastics material encapsulation, the passive sensor part being moulded in one piece on the sliding region. The passive sensor part is preferably also made of plastics material and has been moulded on during the course of the plastics material encapsulation when forming the sliding region.

To hold the windowpane, the driving element is preferably equipped with two clamping jaws, of which at least one is formed by a plastics material encapsulated metal part.

The active sensor part is preferably clipped on the guide rail of the window opener by a clip element. The clip element is preferably moulded in one piece on the housing of the active sensor part.

The passive sensor part can moreover also be integrated in a design or decorative element, in particular a covering element for the drive of the adjusting device. This is particularly recommended when the adjusting device is a seat adjusting device, as the seat rail arrangement of the vehicle seat, for example, may then be at least partially covered by the passive sensor part.

The object according to the invention is also achieved—and this is a second embodiment of the invention—by an adjusting device comprising a sensor system, in which the adjusting device is a window opener, on the driving element of which a magnetic field-changing element is arranged as the passive sensor part for the windowpane.

An adjusting device of this type may also be manufactured very simply and inexpensively—like the above-described first embodiment of the invention comprising a capacitive sensor—as the passive senor part is also arranged on the movable element in this adjusting device and the active sensor part is fastened so as to be secured to the car body.

In this second embodiment of the invention it is also deemed to be advantageous if the passive sensor part forms an integral component, in particular a component of the movable element which is moulded on in one piece.

The “profile” of the passive sensor part changing the magnetic field can be configured in this case in such a way that the active sensor part generates digital, sinusoidal or monotonously increasing or decreasing signals. The profile can in this case passively change the magnetic reflux of an existing magnetic field or alternatively or additionally generate a separate magnetic field. The passive senor part for generating a separate magnetic field may, for example, comprise periodically arranged, equidistant magnetic poles with alternating magnetic field orientation (for example north pole-south pole-north pole-south pole, etc.).

The magnetic field-changing element can also comprise two sensor tracks so absolute location measurement is possible with the aid of the sensor system.

The active sensor part is preferably a magnetoresistive sensor, in particular a Hall sensor. The Hall sensor is preferably biased.

The magnetic field-changing element is, for example, configured in such a way that the magnetic properties vary over the length of the active sensor part in such a way that, in the longitudinal direction of the passive sensor part, the radially oriented magnetic field lines are oriented so as to be rotated about an angle continuously or in segments.

The passive sensor part is preferably formed by an injection-moulded part, in which magnetic material is injected. After injection moulding, the magnetic material is, for example, magnetically oriented by a strong, external magnetic field. Alternatively, the magnetic material can be inserted from the outside into the passive sensor part as separate components.

To describe the invention:

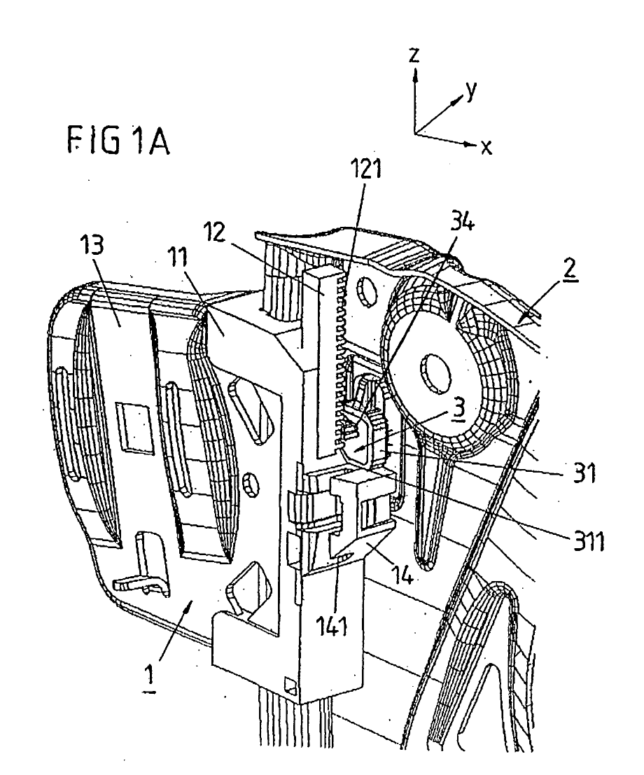

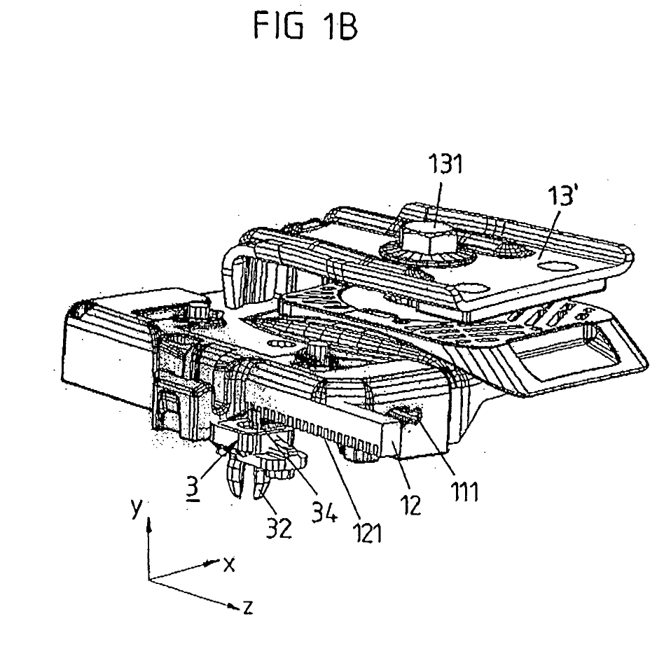

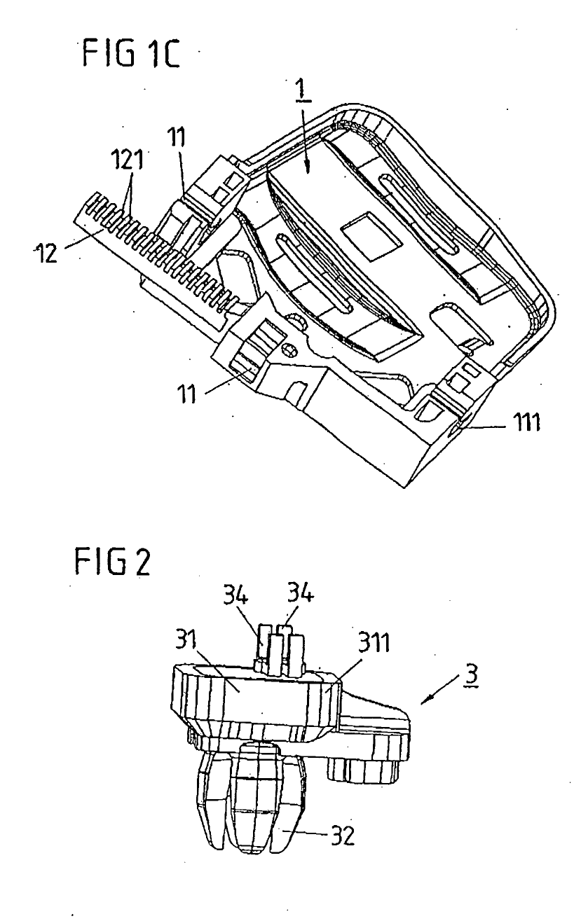

FIGS. 1a to 1c show a first embodiment of an adjusting device according to the invention and, more precisely, in a three dimensional view,

FIG. 2 shows an embodiment of an active sensor part of the adjusting device according to FIGS. 1a to 1c,

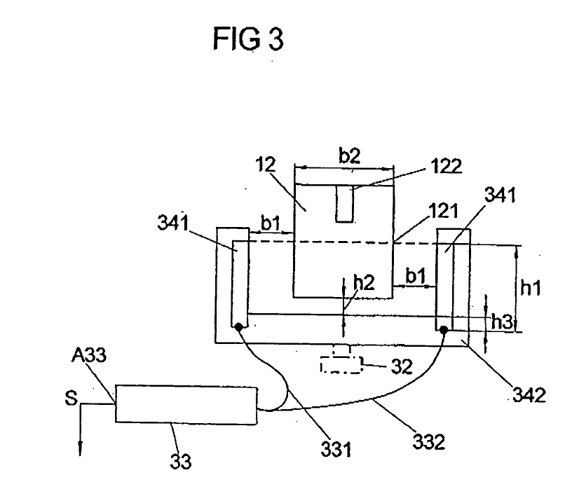

FIG. 3 shows an embodiment of a sensor element of the active sensor part according to FIG. 2,

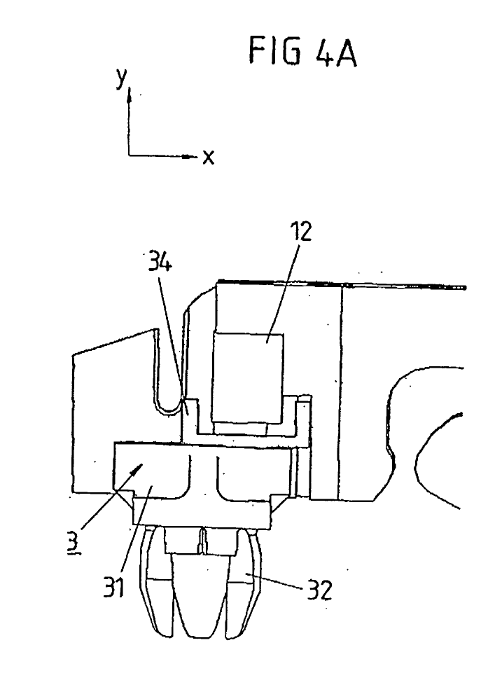

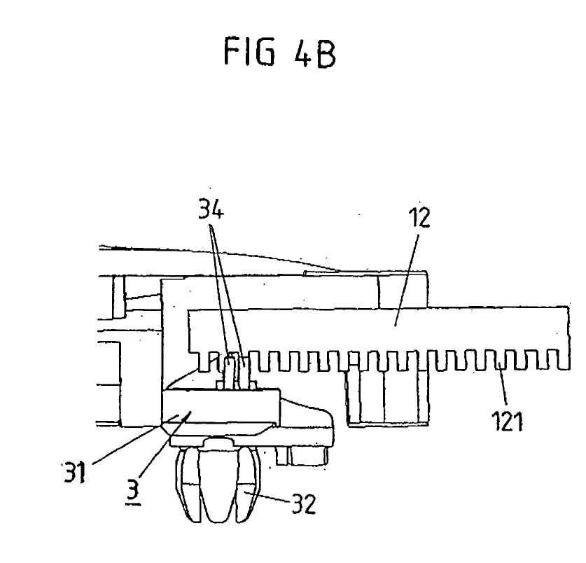

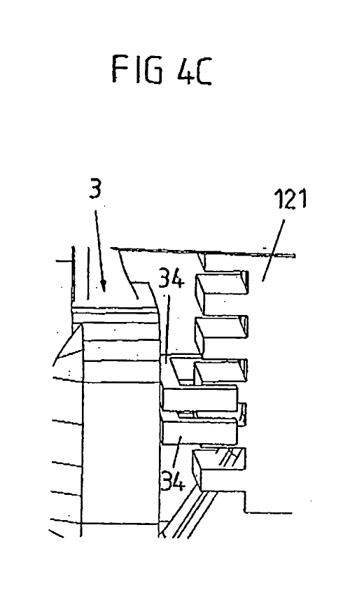

FIGS. 4a, 4b, 4c show detailed views of the relative position of the passive sensor part relative to the active sensor part in the adjusting device according to FIGS. 1a to 1c,

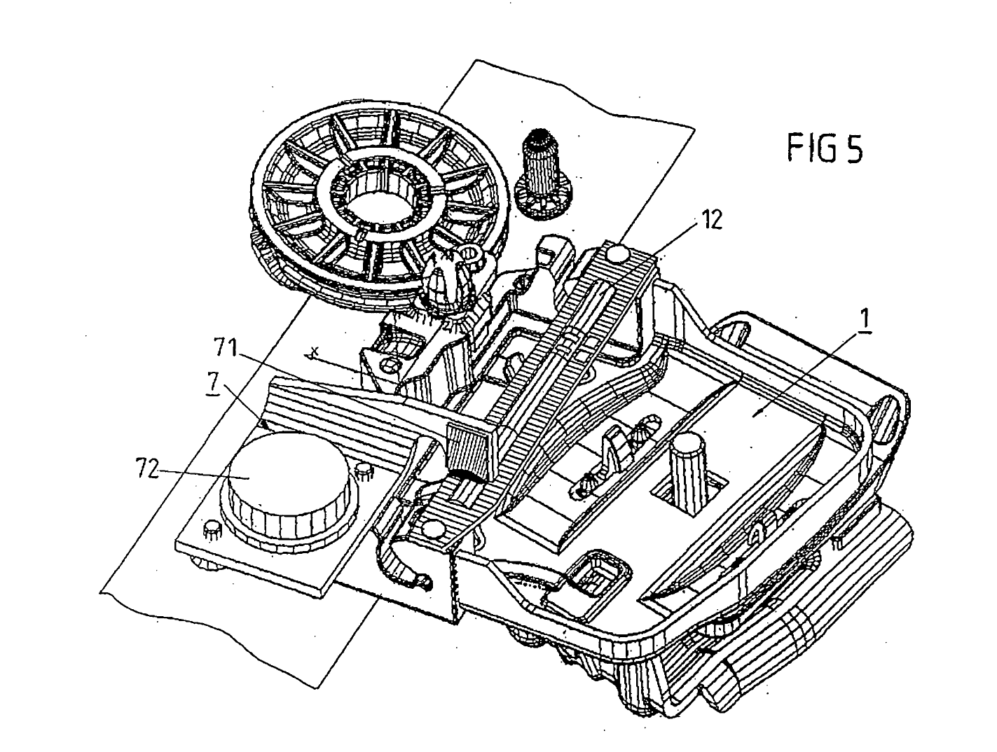

FIG. 5 shows a second embodiment of an adjusting device according to the invention,

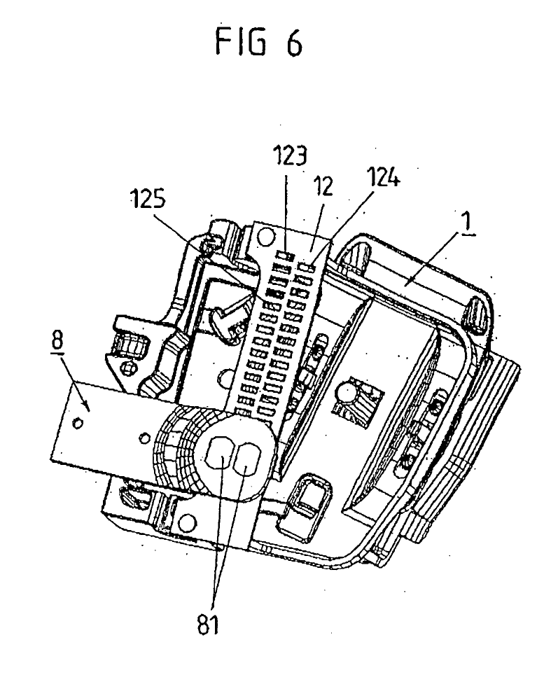

FIG. 6 shows a third embodiment of an adjusting device according to the invention.

FIG. 1a shows a window opener as an adjusting device. The window opener comprises a driving element 1 guided in a guide rail 2. The driving element 1 comprises a slider or sliding region 11 made of plastics material, a passive sensor part 12, a fastening region 13 for fastening a windowpane in the form of at least one clamping jaw 13, and a nipple chamber 14.

An active sensor part 3 is fastened to a housing 31 on the guide rail 2. Fastening of the housing 31 to the guide rail 2 is based on a clip element 32 of the active sensor part 3 that is clipped onto the guide rail 2. An electronic circuit, which generates an electric measuring signal that indicates the position of the driving element 1 relative to the guide rail 2, is arranged in the housing 31 of the active sensor part 3.

The passive sensor part 12 operates as what is called a “scale” and for this purpose has a toothed structure. The scale 12 is guided past two U-shaped sensor elements 34 of the active sensor part 3, so the sensor elements 34 can detect the toothed structure of the scale 12.

A fundamental advantage of this embodiment consists in the fact that no electrical connection lines have to be guided to the movable element in this arrangement, as the active sensor part, which generally requires an electrical connection—apart from radio transmission or the like—is arranged secured to the car body and can therefore be easily electrically connected or “wired”.

FIG. 1b shows a different view of the window opener illustrated in FIG. 1a. In contrast to FIG. 1a, the guide rail 2 has been omitted to allow a better view of the active sensor element 3. A clip element 32 of the passive sensor part 12 can therefore be seen in FIG. 1b. The housing 31 of the passive sensor element 12 is clipped to the guide rail 2 by this clip element 32.

FIG. 1b also shows a second clamping jaw 13′, of which the spacing from the clamping jaw 13 can be adjusted with the aid of a screw 131.

FIG. 1b also shows guide slots 111 with an L-shaped cross-section. The guide slots 111 are used to fasten the driving element 1 to the guide rail 2, not shown in FIG. 1b.

FIG. 2 shows the active sensor element 3 in detail. The clip element 32, in particular, with which the active sensor element 3 is securely connected to the guide rail 2, can clearly be seen. In addition, FIG. 2 shows the two U-shaped sensor elements 34 with which the position of the scale 12 is detected. The two—constructionally identical—sensor elements 34 form a double capacitance sensor.

FIG. 3 shows a detailed cross-section of the construction of the two sensor elements 34. Two parallel capacitor plates 341, arranged in a non-conductive U-shaped holder 342 made of POM plastics material, can be seen. The two capacitor plates 341 are connected to an electronic circuit 33 which at an output A33 emits a position signal indicating the respective position of the scale 12 according to FIG. 1a. The dimensions of the sensor elements 34 may, for example, be selected as follows:
h1=5 mm
h2=1 mm
h3=1 mm
b1=1 mm
b2=3 mm
h2=1 mm

Period length of the profile (with a 50-50 division): 2 mm

With such dimensioning, the capacitance between the two capacitor plates 341 with a stepped profile of the scale 12 changes by about 200 fF on each step change. A rectangular capacitance characteristic with a capacitance stroke of about 200 fF and a mean value of about 1 pF is formed.

FIG. 3 also shows the scale 12 in which a metal sheet 122 is arranged as the carrier part. The toothed profile 121 consisting of plastics material is sprayed or injected onto the metal sheet 122. The scale 12 therefore forms what is known as an outsert part, in other words a part containing a metal core on which the plastics material is sprayed. Alternatively, the scale 12 can also consist exclusively of plastics material and be moulded in one piece directly to the slider or sliding region 11 made of plastics material.

FIGS. 4a, 4b and 4c show in detail the scale 12 and the active sensor part 3 with its sensor elements 34. FIG. 4a shows a view in the Z direction of the motor vehicle. In other words, the view is “vertically downwards”. FIG. 4a shows that the scale 12 is passed between the capacitor plates of the two U-shaped elements 34. The housing 31 and the clip element 32 can also be seen.

FIG. 4b shows a view of the scale 12 and the active sensor part 3 in the X direction of the motor vehicle. FIG. 4b therefore shows that the two U-shaped sensor elements 34 form a double sensor arrangement with a total of four capacitor plates.

FIG. 4c shows the scale 12 equipped with the toothed plastics material profile 121 passing the active sensor part 3 and the U-shaped sensor elements 34, again in a three-dimensional diagram.

FIG. 5 shows a second embodiment of an adjusting device. The passive sensor part 12 is formed by a magnetic rod in which the magnetic properties vary over the length of the magnetic rod and, more precisely, in such a way that, in the longitudinal direction of the magnetic rod, the radially oriented magnetic field lines are oriented so as to be rotated about an angle continuously or in segments. If the driving element 1, and therefore the magnetic rod 12, is moved relative to the guide rail 2, then the magnetic rod 12 moves past an active sensor part 7. The active sensor part 7 comprises a magnetoresistive sensor, for example a Hall sensor 71, with which the orientation of the magnetic field in the magnetic rod 12 is measured. The corresponding sensor signal is evaluated in an electronic circuit 72 of the active sensor part 7, so the position of the magnetic rod 12, and therefore the position of the driving element 1, relative to the guide rail 2 is determined. The electronic circuit 72 emits an electrical—analogue or digital—measuring or positioning signal as an output signal, indicating the position of the driving element 1.

The electronic circuit 72 is accommodated in the housing of the active sensor part 7, so a separate housing for the electronic circuit 72 is dispensed with. The electronic circuit is connected by a cable to a controller—not shown in the figures for reasons of clarity. This controller is configured in such a way that it evaluates the measuring signal of the electronic circuit 72 and controls the drive of the adjusting device by taking into account the position of the driving element 1.

The end of the cable facing the housing and the housing of the active sensor part 7 are jointly encapsulated by plastics material to ensure a water-tight connection.

FIG. 6 shows a third embodiment of an adjusting device. A passive sensor part 12 with two sensor tracks 123 and 124 can be seen. A respective separate sensor element 81 of an active sensor part 8 is associated with each of these two sensor tracks 123 and 124. The two sensor elements 81 can be double capacitance sensors in each case. The double capacitance sensors can be formed, for example, from the sensor elements 34 described in conjunction with FIGS. 2 and 3.

The two sensor tracks 123 and 124 comprise recesses 125 arranged in such a way that they form a code. When the driving element 1 passes the guide rail 2 the recesses 125 pass the associated sensor elements 81 of the active sensor part 8. The absolute position of the driving element 1 relative to the guide rail 2 may therefore be established with suitable coding. Absolute position determining is even possible in this case if the driving element 1 is stationary, in other words is not moving past the guide rail 2.

### List of Reference Numerals

1 driving element

2 guide rail

3 active sensor part

7 active sensor part

8 active sensor part

11 slider (sliding region)

12 passive sensor part

13; 13′ clamping jaws (fastening region for windowpane)

14 nipple chamber

31 housing

32 clip element

33 electronics

34 sensor element

71 hall sensor

72 electronic circuit

81 sensors

111 guide slot with l-shaped cross-section

121 profile

122 carrier part

123, 124 sensor tracks

125 recesses

131 screw

141 recesses in the nipple chamber

311 abutment face

1. Adjusting device for a motor vehicle for adjusting a movable element (1) of the adjusting device with a sensor system comprising at least one active sensor part (3) and at least one passive sensor part (12),
characterised in that
the active sensor part (3) is a fixed capacitive sensor and the passive sensor part (12) forms a component of the movable element (1).

2. Adjusting device according to claim 1, characterised in that the passive sensor part (12) forms an integral component of the movable element (1).

3. Adjusting device according to claim 2, characterised in that the passive sensor part (12) is moulded in one piece onto the movable element (1).

4. Adjusting device according to claim 1, characterised in that the passive sensor part (12) comprises a capacitance-changing profile (121).

5. Adjusting device according to claim 4, characterised in that the profile (121) is toothed or sinusoidal.

6. Adjusting device according to claim 4, characterised in that the profile comprises at least one monotonously increasing or at least one monotonously decreasing characteristic.

7. Adjusting device according to claim 1, characterised in that the passive sensor part (12) comprises at least two sensor tracks (123, 124).

8. Adjusting device according to claim 1, characterised in that the profile (121) is constructed from a plastics material.

9. Adjusting device according to claim 8, characterised in that the plastics material is injected or sprayed onto an in particular metal carrier part (122), in particular with the formation of an outsert part.

10. Adjusting device according to claim 1, characterised in that the carrier part (122) is constructed in such a way that, on passing the passive sensor part (12) on the active sensor part (3), it leaves the electrical field in the region of the active sensor part (3) unaffected.

11. Adjusting device according to claim 1, characterised in that the carrier part (122) also comprises a capacitance-changing profile.

12. Adjusting device according to claim 1, characterised in that the active sensor part (12) is clipped onto a carrier element (2) secured to the car body by means of a clip element (32), the clip element (32) preferably being connected in one piece to a housing (31) of the active sensor part and also preferably being made of plastics material.

13. Adjusting device according to claim 1, characterised in that the housing (31) of the active sensor part (3) forms at least one abutment face (311) for the movable element (1), on which face the movable element (1) abuts at least in one of its two end positions.

14. Adjusting device according to claim 1, characterised in that the sensor system comprises an evaluation device, in particular an electronic circuit (72), which evaluates the sensor signal of the active sensor part (3), the evaluation device (72) preferably being configured in such a way that, from the sensor signal of the active sensor part (3), it forms an analogue or digital measuring signal which indicates the absolute or relative position of the movable element (1).

15. Adjusting device according to claim 14, characterised in that the evaluation device (72) is stationarily fastened, the evaluation device (72) preferably being housed in the housing (31) of the active sensor part (3).

16. Adjusting device according to claim 14, characterised in that the evaluation device (72) is connected via at least one cable to a controller of the adjusting device, connected to a drive of the adjusting device, and in that the controller is configured in such a way that it evaluates the analogue or digital measuring signal of the evaluation device (72) and controls the drive by taking in to account the absolute or relative position of the movable element, the at least one cable and a housing of the evaluation device (72) preferably being connected in a water-tight manner.

17. Adjusting device according to claim 16, characterised in that the evaluation device (72) is housed in the housing (31) of the active sensor part (3) and the housing (31) of the active sensor part (3) and the cable are connected in a water-tight manner.

18. Adjusting device according to claim 17, characterised in that the water-tight connection between the cable and the housing of the evaluation device (72) and the housing (31) of the active sensor part (3) is brought about in that the end of the cable facing the housing (31) and the housing (31) are jointly encapsulated by plastics material.

19. Adjusting device according claim 1, characterised in that the adjusting device is a window opener and a fastening region (13) of the driving element (1) used to fasten the windowpane, in particular for example a clamping jaw (13) of the fastening region, consists of metal and is connected by plastics material encapsulation to a sliding region (11) of the driving element (1) guided by the guide rail (2) of the window opener, the passive sensor part (12) being integrally moulded on the sliding region (11).

20. Adjusting device for a motor vehicle for adjusting a movable element of the adjusting device comprising an active and a passive sensor part, characterised in that the adjusting device is a window opener, on the driving element (1) of which a magnetic field-changing element is arranged as a passive sensor part for the windowpane.

21. Adjusting device according to claim 20, characterised in that the passive sensor part (12) is an integral component of the driving element (1).

22. Adjusting device according to claim 20, characterised in that the passive sensor part (12) is connected in one piece to the driving element (1).

23. Adjusting device according to claim 20, characterised in that the passive sensor part is configured in such a way that it changes the magnetic field generated by the active sensor part.

24. Adjusting device according to claim 20, characterised in that the passive sensor part (12) comprises at least one permanent magnetic region, of which the magnetic field is detected by the active sensor part (7).

25. Adjusting device according to claim 20, characterised in that the profile of the passive sensor part is toothed or sinusoidal.

26. Adjusting device according to claim 20, characterised in that the profile of the passive sensor part comprises at least one monotonously increasing or decreasing characteristic.

27. Adjusting device according to claim 20, characterised in that the passive sensor part comprises periodically arranged, equidistant magnetic poles with a changing magnetic field orientation.

28. Adjusting device according to claim 20, characterised in that the passive sensor part comprises at least two sensor tracks which are preferably arranged with respect to each other in such a way that measurement of the absolute position is possible even when the movable element is stationary.

29. Adjusting device according to claim 20, characterised in that the active sensor part (7) comprises a magnetoresistive sensor, in particular a Hall sensor (71).

30. Adjusting device according to claim 29, characterised in that the Hall sensor (71) is electrically or magnetically biased.

31. Adjusting device according to claim 20, characterised in that the magnetic properties of the passive sensor part vary over its length in such a way that, in the longitudinal direction of the sensor part, the radially oriented magnetic field lines are oriented so as to be rotated about an angle continuously or in segments.

32. Adjusting device according to claim 20, characterised in that the passive sensor part comprises an injection-moulded part in which magnetic material is injected.

33. Adjusting device according to claim 32, characterised in that, after injection moulding, magnetic material is magnetically oriented by a magnetic field.
